(19) United States
(12) Patent Application Publication
(10) Pub. No.: US 2016/0162645 A1
(43) Pub. Date: Jun. 9, 2016

(54) System and Method for Normalizing and Communicating Care Plans

(71) Applicant: Filament Labs, Inc., Austin, TX (US)

(72) Inventors: Jason Bornhorst, Austin, TX (US); Colin Anawaty, Austin, TX (US); Brian Gambs, Austin, TX (US)

(21) Appl. No.: 14/560,499

(22) Filed: Dec. 4, 2014

(51) Int. Cl. G06F 19/00

(52) U.S. Cl. CPC G06F 19/325

(57) ABSTRACT

A system and method for normalizing and communicating health care plans is provided. In one aspect of the invention, the method includes converting one or more care plans into a common digital format, identifying tasks within the care plans, determining if one or more of the tasks are in a standardized form, and classifying the tasks if the tasks are in a standardized form. In another aspect of the invention, the method includes unifying the one or more care plans, selecting one or more communication mediums for communicating care plans, and communicating the care plans to one or more users and or patients.

### BACKGROUND OF THE DISCLOSURE

In general, treatment of patients having comorbidity costs the healthcare system much more than it costs to treat patients without comorbidity. Moreover, many comorbid patients still struggle to effectively treat their health.

Comorbid patients are those diagnosed with one or more illnesses that are co-occurring. One reason that may result in the failure of comorbid patients to effectively treat their health is poor compliance or adherence when executing health care plan instructions. Moreover, because comorbid patients often see more than one physician, comorbid patients often receive fragmented health care coordination. Also, due to confusing or potentially hazardous care plan instructions, many comorbid patients cease to follow care plans directives. This can worsen the problem and add to the increased cost of health care.

Care plans are typically used to provide information and instruction to patients for the management and recovery of their health. These care plans are used by professional health care providers such as hospitals and clinics, but may also be used by professional health care providers in assisted living situations and home care. Moreover, care plans may come in many different forms and may be used for many different purposes.

A discharge folder is one example of a paper-based care plan that can contain patient discharge instructions and other useful information that patients may review at home after being discharged from a hospital. Discharge folders may also include a list of tasks a patient needs to perform so that the patient can experience a better recovery. For example, a discharge folder may contain a list of instructions directing patients to take a certain medication a number of times each week. As another example, a discharge folder may contain instructions directing patients to perform certain exercises periodically, or contain educational information related to the illness.

Although, the typical care plan provides information and instruction necessary for the successful recovery of a patient, many care plans utilized by health care providers are not normalized across systems and are often altered and communicated to patients in writing using short hand notation or other means.

Further, though some providers of care plans communicate health care information using electronic means such as computers, because of the lack of care plan normalization, many care plans cannot be altered in real time, merged, or effectively communicated and understood between different systems. This is especially true with multiple distributed care plans that have not been compared and normalized for consistency to address a patient's unique needs.

It is therefore desirable to have a system and method for normalizing multiple care plans. It is also desirable to have a system and method that supports multidirectional modification and communication of normalized care plans. The subject matter of the present disclosure is directed to addressing one or more of the problems set forth above.

### SUMMARY OF THE DISCLOSURE

A system and method for normalizing and communicating health care plans is provided. In one aspect of the invention, the method includes digitizing, unifying, and communicating one or more health care plans. In one example, the method includes digitizing care plans by converting the care plans into a common digital format, identifying tasks within the one or more care plans, and classifying the tasks if the tasks are in a standardized form. According to another aspect, the method standardizes tasks within the one or more care plans by formatting the tasks, receiving input for selecting options related to a user's health, and associating content with the tasks.

In still another aspect of the invention, the method unifies one or more care plans into a unified care plan and communicates the unified care plan to users. In this aspect, the method includes using internal and or external resources for identifying potentially hazardous care plan content. In another aspect of the invention, the method includes selecting one or more communication mediums for communicating unified care plans. In yet another aspect of the invention, the method allows personalizing a unified care plan by allowing the care plan content such as color, font, contrast, sound, orientation, metadata, and or style to be modified. In another aspect of the invention the method allows personalizing of care plan content through the use of a GUI interface.

According to another aspect, the method allows formatting care plan tasks by formatting one or more quantitative expressions and language content using location information. A different aspect of the invention also allows communicating associated content information with the care plan communication.

The foregoing summary is not intended to summarize each potential embodiment or every aspect of the present disclosure.

### BRIEF DESCRIPTION OF THE DRAWINGS

FIG. 1 illustrates a system diagram of a healthcare management system (HMS) according to the present disclosure.

FIG. 2 illustrates a system diagram of a digitization module of the HMS according to the present disclosure.

FIG. 3 illustrates a system diagram of a unification system of the HMS according to the present disclosure.

FIG. 4 illustrates an example HMS process according to the present disclosure.

FIG. 5 illustrates an example digitization process according to the present disclosure.

FIG. 6 illustrates an example standardization process according to the present disclosure.

FIG. 7 illustrates a block diagram of the HMS of FIG. 1 according to the present disclosure.

FIGS. 7A-7D are block diagrams of the hardware, software and data of the computers of FIG. 7.

FIG. 8 illustrates example health care plans according to the present disclosure.

FIG. 9 illustrates a flow diagram of a digitization process according to the present disclosure.

FIG. 10 illustrates a flow diagram of a unification process according to the present disclosure.

FIG. 11 illustrates a flow diagram of a communication process according to the present disclosure.

FIG. 12 illustrates one example of a unified care plan accessed through a web portal using a client device according to the present disclosure.

FIG. 13 illustrates an additional example of a unified care plan accessed through a web portal using a client device according to the present disclosure.

FIGS. 14A-14B illustrate additional examples of health care plans according to the present disclosure.

FIG. 15 illustrates an additional example of a unified care plan accessed through a web portal using a client device according to the present disclosure.

FIG. 16 illustrates an additional example of a unified care plan accessed through a web portal using a client device according to the present disclosure.

FIG. 17 illustrates an example prompt generated by the system requesting input from a user.

### DETAILED DESCRIPTION OF THE DISCLOSURE

Overview of the System

A brief overview of the architectural components and their relationships between each other will now be described.

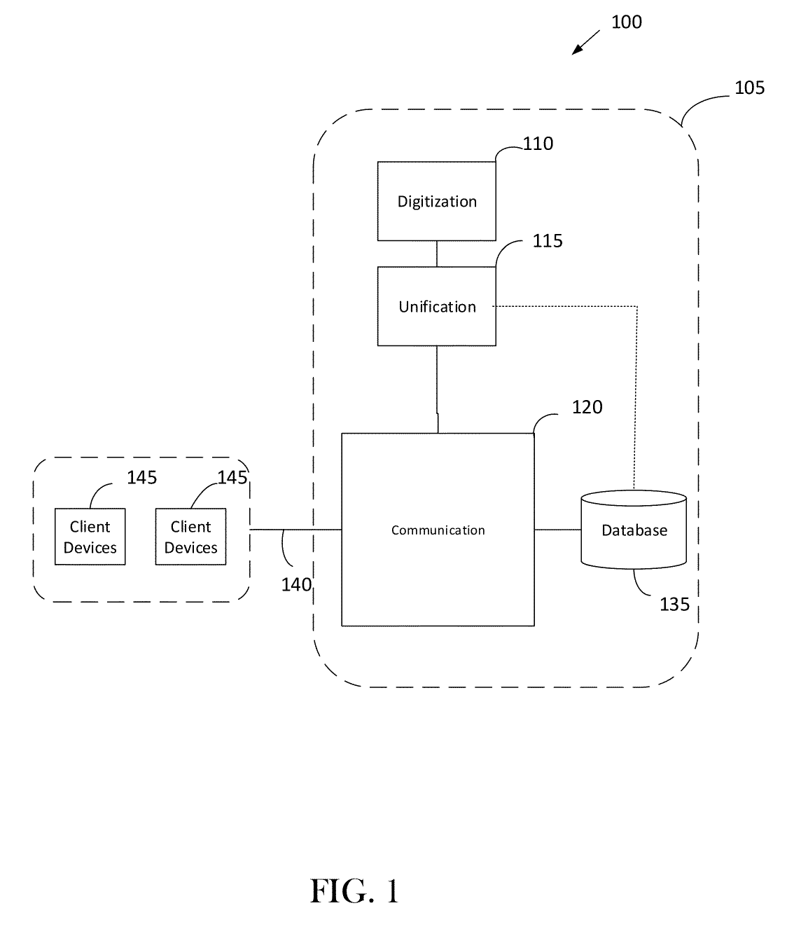

FIG. 1 illustrates a system diagram of a HMS 100 used for normalizing and communicating care plans according to the present disclosure. As shown, the HMS 100 includes a digitization module 110 for digitizing one or more health care plans. Also as shown, the HMS 100 may be implemented on one or more host servers or other device 105 having memory, one or more processors, and at least one wired or wireless communication interface 140 for establishing communications with one or more client devices 145.

The system 100 also includes a unification module 115 for unifying healthcare plans into a single unified plan. Also as shown, a communication module 120 is communicatively coupled to the digitization module 110 and unification module 115. As discussed below, the communication module 120 is used to communicate care plan content with one or more client devices 145.

The communication module 120, is used to assist users (e.g., physicians, healthcare professionals, family, etc.), and patients in selecting one or more communication mediums such as email, text messaging, etc, to be used during care plan communication.

Also, as shown, the communication module 120 is communicatively connected with one or more client devices 145 such as cellular phones, personal digital assistants (PDAs), computers, or other digital devices. By communicating with one or more client devices 145, the communications module may allow a users and patients to access care plan information through a web portal using graphical user interface (GUI).

Further as illustrated, and also communicatively coupled to the communication module 120, is a database 135 that stores information related to a patient's healthcare including one or more healthcare plans, medical records, and or other related information. In one example, the database 135 is communicatively coupled to the digitization module 110 and or unification module 115.

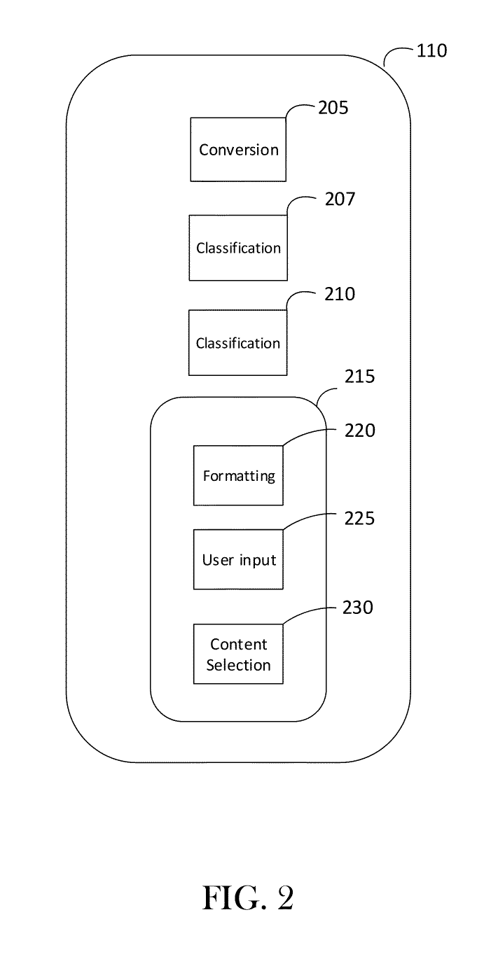

Referring to FIG. 2, a system diagram of a digitization module 110 of the HMS 100 is shown. As described below, the digitization module 110 includes a conversion module 205 which is used to convert one or more healthcare plans into a digital format. The digitization module 110 also includes a classification module 210 for classifying care plan content after the care plans have been converted. Also as shown, the digitization module 110 includes a standardization module 215 for standardizing care plan content after the care plans have been converted to a digital format.

Referring now to the standardization module 215, as will be described in detail below, the standardization module 215 includes a formatting module 220 for formatting healthcare plan content into a common format, a user input module 225 for receiving healthcare related information from a users and patients, and a content selection module 230 for associating content with one or more care plan.

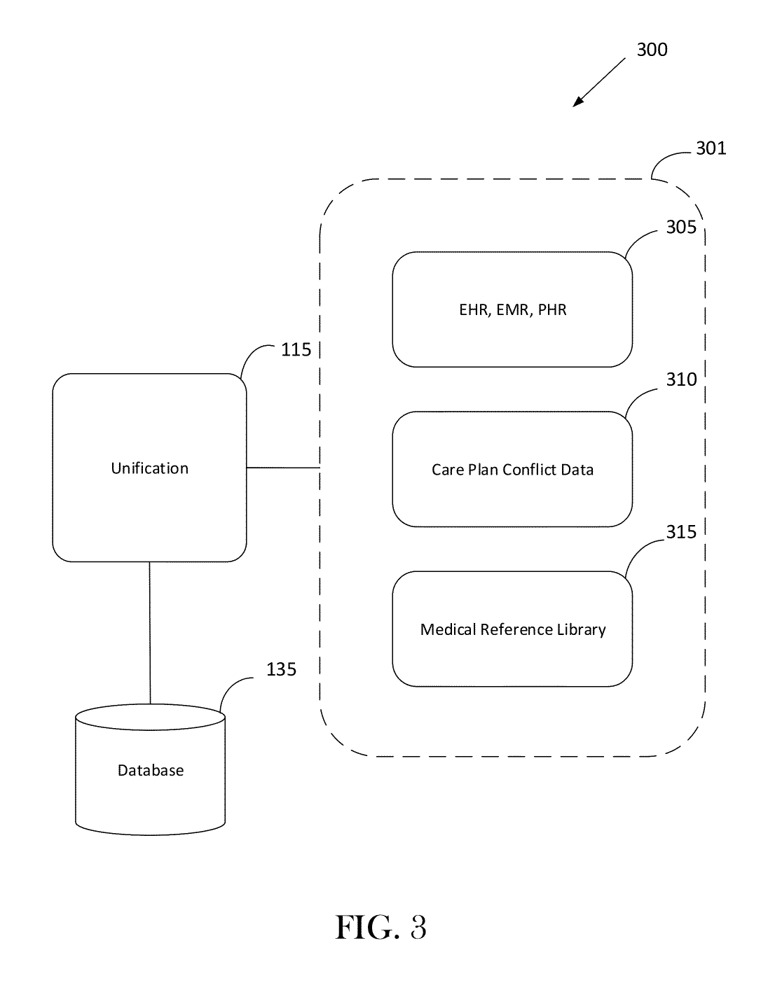

Referring now to FIG. 3, a system diagram of an HMS 100 unification system 300 is shown according to the present disclosure. As described below, the unification system 300 includes a unification module 115. The unification module 115 is used to merge one or more digitized care plans into a unified care plan.

Also as shown, the unification module 115 is communicatively coupled to a database 135 and or external resources 301 such as a patient's medical record data 305, known medical conflict data 310, and or medical reference libraries 315. Using the information in the database and or external resources, the unification module 115 may identify potentially hazardous health care conflicts, and report the conflicts to one or more users.

Digitization, Unification, and Communication

The above discussion was primarily focused on HMS 100 components used to implement the method for normalizing (i.e., digitizing and unifying), and communicating care plans. The below discussion will now focus on the process of normalizing and communicating care plans.

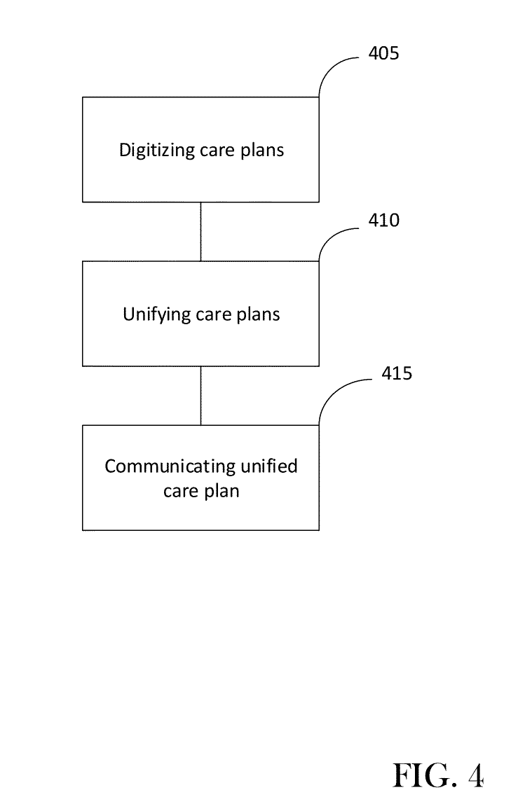

Referring to FIG. 4, an example of the HMS (100) process is shown according to the present disclosure. In one example, at step 405 the HMS (100) process digitizes one or more care plans if it is determined that the care plans are not in a common digital format. A care plan will be in a common digital format if the care plan is in a common digital format that is interpretable by the HMS (100).

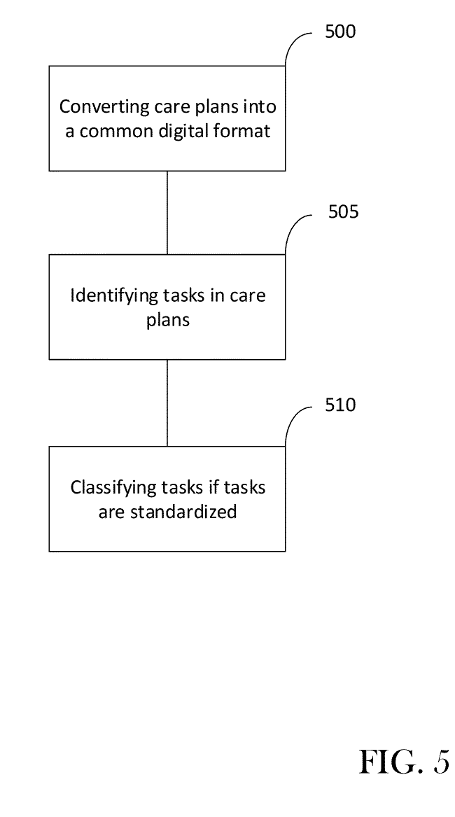

Referring to the details of the digitization process in FIG. 5, if it has been determined that one or more care plans are not in a common digital format, the method digitizes the care plan content at step 500 by converting the one or more care plans into a common digital format. This conversion process is performed by the digitization module (110) discussed above.

After converting the care plans into a common digital format at step 500, the digitization process continues at step 505 by identifying one or more tasks within each care plan. Health care tasks may be any content (e.g., instructions, etc.) directed to the management and or maintenance of a patient's health.

Once the health care tasks have been identified, the digitization process at step 510 determines whether the tasks are in a standardized format. A task will be in a standardized format if the task is in format consistent with the system's (100) task format settings. The system's task format settings may be predefined or modified by a user of the HMS 100.

After the digitization process determines that the tasks are standardized at step 510, the digitization process classifies the tasks by associating with them one or more care plan tags. A care plan tag may be task descriptive content or metadata that the system (100) can use to readily interpret health care tasks. Task classification is implemented by the classification module (210).

As discussed above, if the digitization process determines that the healthcare plan tasks have been standardized at step 510, the digitization process will classify the tasks by associating them with tags. However if the digitization process determines at step 510 that the tasks have not been standardized, the non-standardized tasks are standardized by the standardization module (215) described above.

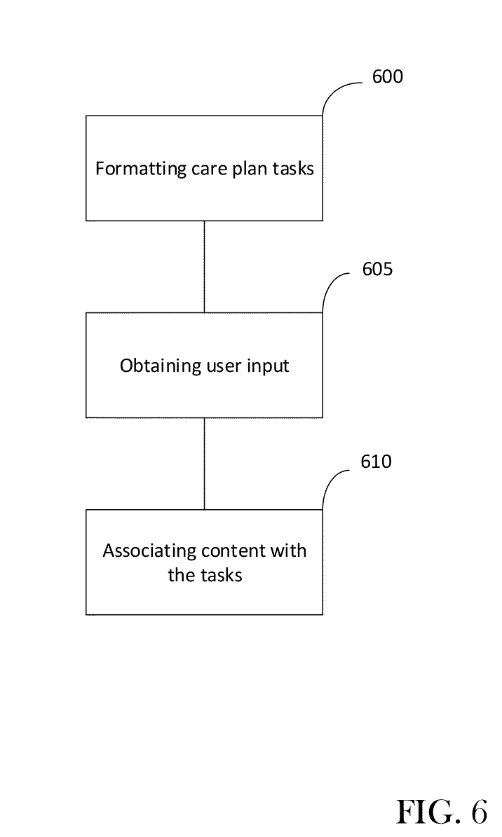

FIG. 6 illustrates an example process for standardizing care plan tasks. At step 600, the standardization process standardizes one or more tasks. Standardizing tasks may include identifying numerical data within a task of a plan and formatting the numerical data so that it is in standard form. Conversion settings are used during the standardization process for indicating how to format the numerical data.

In one example, based on the numerical format settings, the formatting step 600 of the standardization process detects user and or patient preferences and or location data stored on the user's client device (145). Using this data, the HMS (100) formats the patient's health care plan content (e.g., care plan tasks) in a way that is consistent with the patient's and or the user's preferences, location, and or geographical customs.

In another example, instead of automatically detecting the location of a user and or patient from the location data located on the client device (145), the client device (145) may have a home setting that can be selected. In this example, regardless of the location data of the device, if the home setting has been selected, the patient's care plan or health information will be formatted so that the patient or user may view the care plan in a preselected language.

In addition to formatting tasks, at step 605 the standardization process allows the system (100) to receive input related to a patient's health. In one example, a user input module (225) is used to implement this process. In this example, a user or the patient is allowed to give input related to a patient's history of prior illnesses. The user input module (225) can receive input from the user and or the patient using a multiple choice query or other prompt that can be used to gather important health information.

Referring to step 610, the standardization process associates content with one or more care plan tasks. In one example, this may be performed by the content selection module 230 discussed above. The associated content may be educational in nature and may be related to one or more care plan tasks. Once the content has been associated with a care plan task, a user and or patient may access the content during care plan communication.

Returning to FIG. 4, after the digitization process (405) has digitized the one or more healthcare plans, including the classification and standardization of the care plan tasks, the process continues at 410 by unifying the one or more care plans. In one example, the unification process 410, implemented by the unification module (115) of the unification system (300) is used to combine the one or more care plans into a unified care plan. In another example, the unification process 410 identifies and flags task conflicts (e.g., conflicting medications, etc.) using care plan conflict data (310). In yet another example, the unification process 410 uses the HMS database (135) and or other external resources (301) to provide content related to a patient's one or more illnesses.

Referring to step 415 of FIG. 4, after the care plans have been unified into a unified care plan, the care plan is communicated to one or more users and or patients using one or more communication mediums. Communication of the care plans is implemented using the communication module (120). During the selection of the one or more communication mediums, the communication module (120) may receive input related to a user and or patient's preferred communication type. In one example, after a communication medium has been selected, the process communicates the care plan directly to the user and or patient using that communication medium.

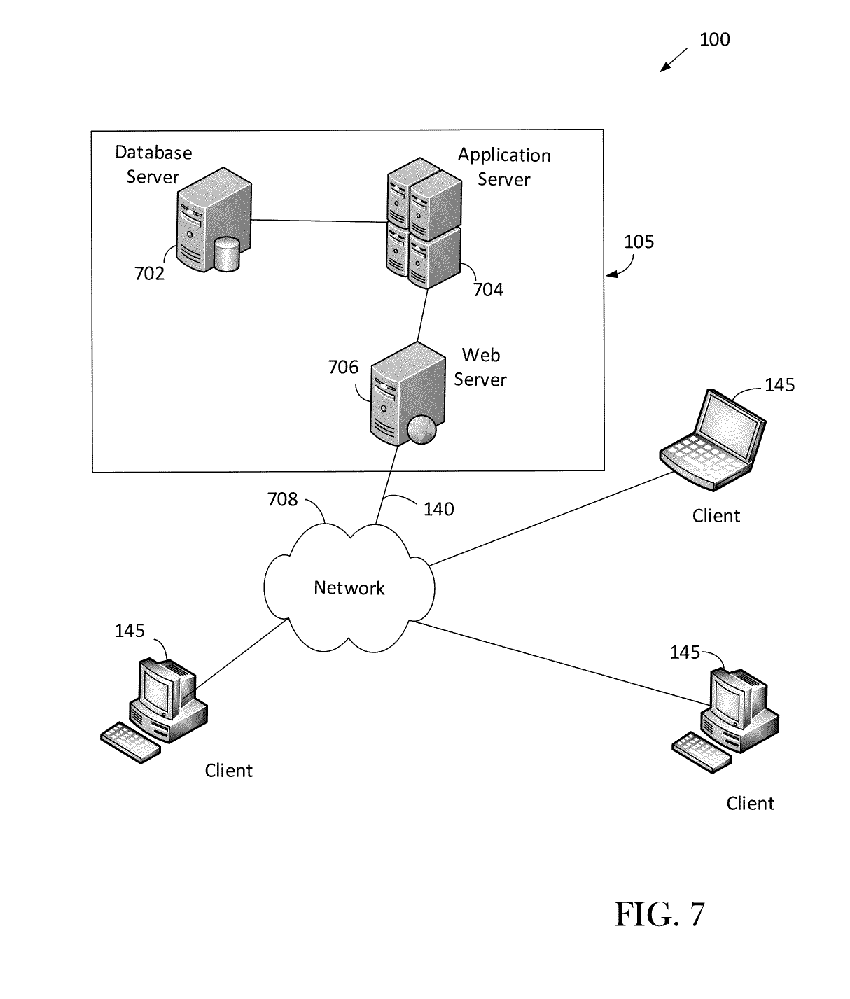

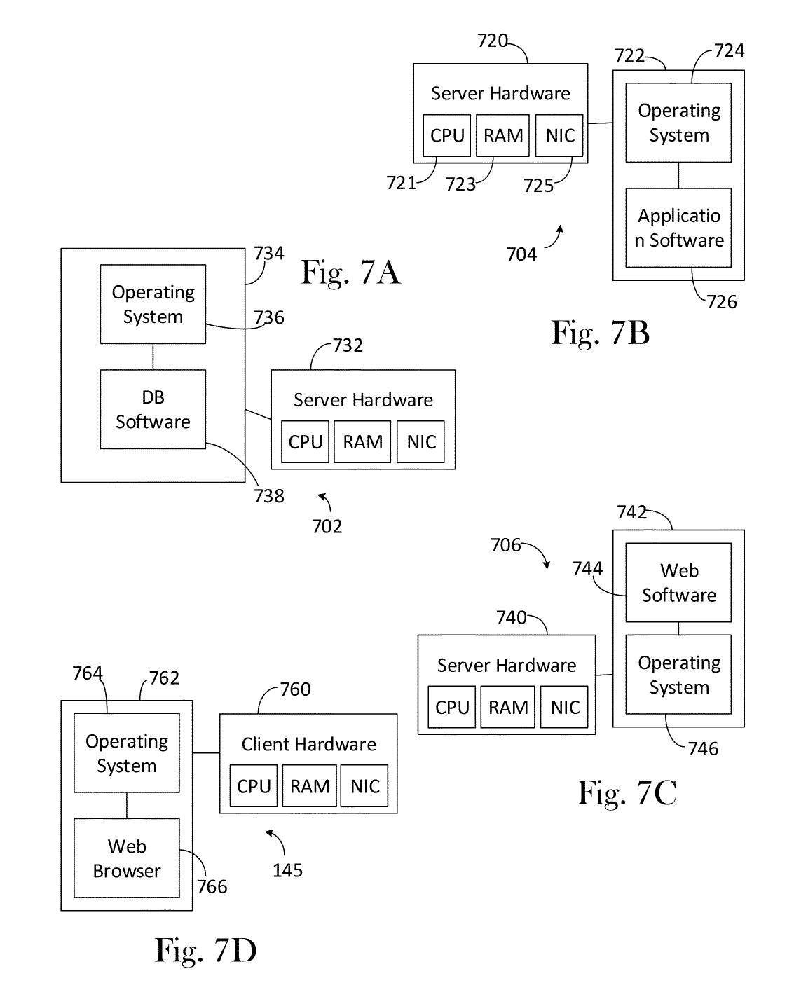

FIG. 7 illustrates a block diagram of the HMS 100 of FIG. 1 according to the present disclosure. As discussed above, the HMS 100 may be implemented on one or more servers 105 having memory, one or more processors, and at least one wired or wireless communication interface 140 for establishing communications with one or more client devices 145.

The HMS 100 can be provided on an application service provider (ASP) or software as a service (SaaS) model or otherwise hosted, as either a single or multi branch configuration. Communication between client devices 145 and the servers is provided by the Internet, intranet, LAN, WAN or a combination of networks.

The application of the HMS 100 is hosted on a server system 105 consisting of one or more computers in communication with each other, among them performing the functions of a database server 702, an application server 704 and a web server 706. Although, three separate server computers are illustrated in FIG. 7, one or more server computers may be used to implement the system.

During operation, each server will carry out different portions of the overall functionality of HMS 100. For example, the application server 704 may take requests from the web server 706, process data, and returns results back to the web server 706. The requests are usually data manipulation requests and the application server 704 closely interacts with the database server 702 during data processing.

Referring to FIGS. 7A-7D, in the preferred embodiment, the application server 704 includes server hardware 720 and storage 722, such as a hard disk drive or the like. The server hardware 720 includes a CPU or processor 721, RAM 723 and network interface (NIC) 725. Windows Server from Microsoft is the preferred operating system 724 stored by the storage 722. It is understood that this is exemplary and can evolve over time to use different operating systems. The application server 704 also includes, as part of its application software 726 stored on the storage 722, an open data base connectivity (ODBC) server to enable received ODBC compliant messages to be interpreted and executed by the database server 702 and, additionally, to generate and transmit ODBC compliant messages.

The web server 706 includes server hardware 740 (similar to server hardware 720) and storage 742, which includes an operating system 746 and web server hosting software 744 capable of receiving HTTP requests, receiving data posted to HTML or XML pages, interpreting received requests, retrieving requested web pages (e.g., HTML or XML pages), transmitting retrieved pages and transmitting other data through use of HTTP. In the preferred embodiment web server hosting software 744 is provided using Microsoft IIS including the .NET framework, though it is understood that other web environments can be used.

The database server 702 includes server hardware 732 (similar to server hardware 720) and storage 734, which includes an operating system 736 and a database management system (DBMS) 738. The DBMS 738 in the preferred embodiment is implemented using conventional SQL compliant relational database management (RDBMS) software such as those available from IBM, Microsoft, Oracle and the like. The DBMS 738 operates to create, maintain, update, query and otherwise control data stored on the storage 734 in data tables, which form the database.

The storage 734, 722 and 742 are examples of computer readable medium or media having computer-executable instructions stored thereon for operating the HMS 100 to perform method embodiments according to the present invention.

Each client 145 includes client hardware 760 (similar to server hardware 720) and storage 762. In the preferred embodiment, the operating system 764 of these clients 145 is a suitable version of Google Android, Apple iOS, or Microsoft Windows, though other operating systems can be used. The clients 145 in communication with server system hosting application have client software such as a browser 766, i.e., Microsoft Internet Explorer in the preferred embodiment, though it is understood that other browsers such as Chrome, Firefox, Opera, Safari, and the like can be used. The clients 145 have access to the HMS 100 via the network 708, which network can be the Internet, an intranet LAN or WAN connection or a combination.

The HMS 100 can be accessed by users and or patients using conventional computers, workstations, hand-held devices, PDA's, smartphones, or other client devices 145. Each client device 145 also includes hardware, one or more processors, and memory configured to communicate with the HMS 100 through a network 708. The client devices 145 may communicate with the server system 105 using software such as a web browser.

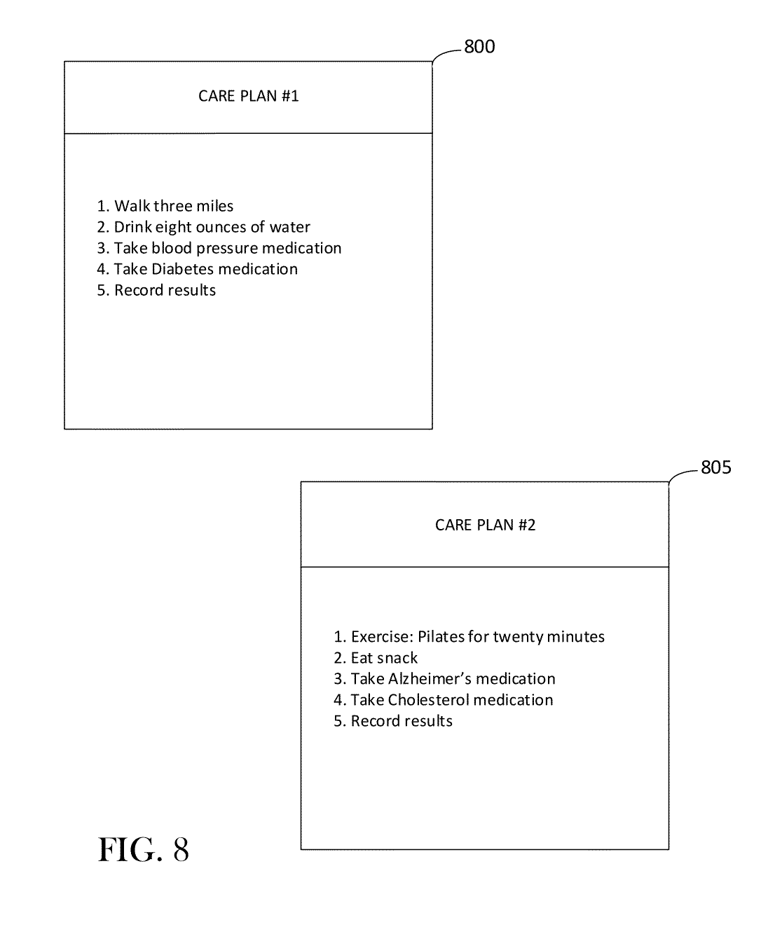

Referring to FIG. 8, example health care plans are shown according to the present disclosure. In one example, one or more of the care plans may be issued to a comorbid patient (i.e., a patient having one or more co-occurring illness). For example, as shown, the first care plan 800 may be derived from a physician or other health care professional for a patient having been diagnosed with high blood pressure and diabetes, while the second care plan 805 may be derived from a different physician or care professional for the same patient. The second care plan may be derived for treating one or more additional illnesses (e.g., Alzheimer's disease and high cholesterol). However, it is not necessary for a comorbid patient to receive more than one care plan, as it is possible for a comorbid patient to receive a single care plan for treating two or more co-occurring illnesses.

As shown, each care plan 800, 805 has within it one or more tasks. For example, one task as shown in the first care plan 800 directs the patient to walk three miles and to take a certain blood pressure medication. Also, examples of tasks in the second care plan 805 include directing the patient to do Pilates exercises and to take cholesterol medication. As discussed above, the HMS 100 may be used to normalize one or more of the first and second care plans of FIG. 8, by digitizing the care plans if they are not in a common digital format, and unifying the care plans by identifying and flagging potentially hazardous task conflicts and by merging the care plans into a unified care plan for communication to one or more users and or patients.

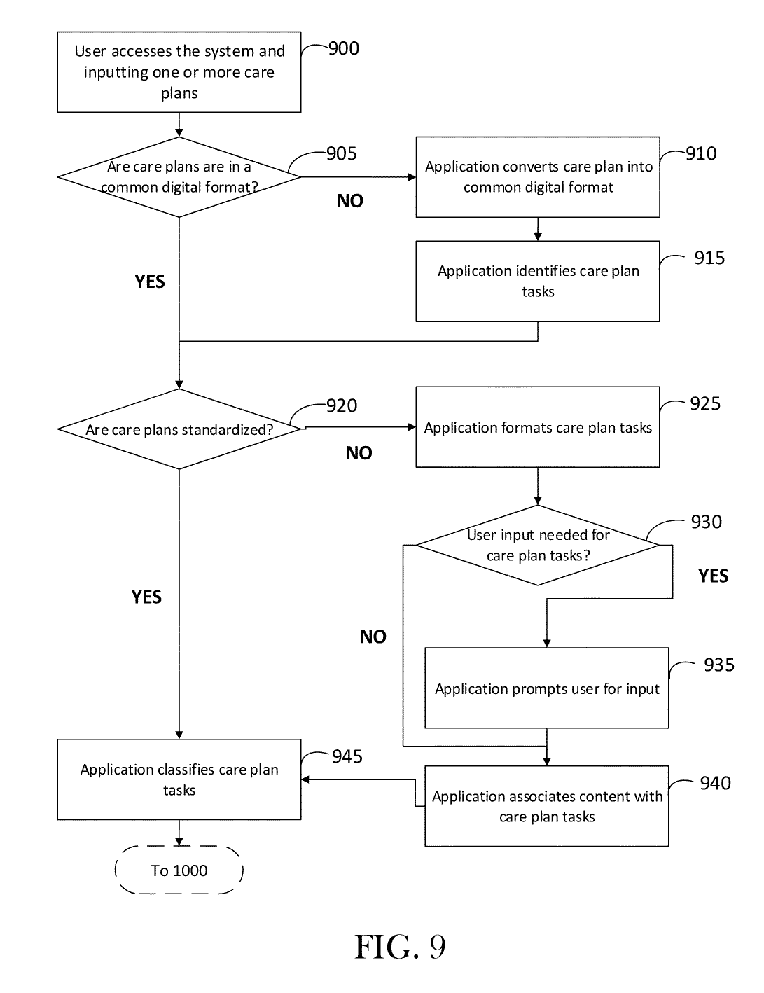

Using the flow diagram of FIG. 9, and the first and second care plans described above, an example process of normalizing and communicating care plans is illustrated. In one example, once the HMS (100) has been executed on the server system (105), the process of normalizing health care plans begins by a user accessing the system and inputting one or more of the care plans into the HMS (100) as shown at step 900. A user may access the HMS (100) either through a computer or workstation directly communicating with the server system (105), or through the internet (e.g., through a web portal) using one or more client devices (145).

After accessing the HMS (100), the one or more care plans are input into the system (100). For example, in one example both the first care plan (800) and second care plan (805) are input into the system (100) by converting the health care plans into a format suitable for electronic document exchange, such as portable document format (PDF) or other format. In addition, inputting the one or more care plan may also be performed by integrating the HMS (100) with external resources such as a patient EHRs. This is because EHRs may have care plans that are typically in an unstructured form e.g., unstructured notes written in Microsoft Word. By integrating the HMS (100) with the patient's EHR such as Epic or Allscripts, the system (100) can automatically import the care plans/discharge notes and covert the care plans/notes into a more suitable format.

Once the care plans are in a suitable format for exchange, they are uploaded to the HMS (100). In this aspect, the HMS (100) can allow the user to browse for the health care plans and upload them to the HMS (100).

After the care plans have been uploaded into the HMS (100), at step 905 the HMS (100) determines if the care plans are in a common digital format that is interpretable by the HMS (100). Determining whether the care plans are in a common digital format includes determining if there is any content within the care plans that is not in a digital format. If at least parts of the care plans are determined not to be in a digital format, a conversion process at step 910 is used to convert the non-digital content into a digital form using conventional or adaptive optical character recognition (OCR) techniques known in the art.

In one example, one conventional OCR technique may be used to analyze text to establish a typeface and font size, or other objects by calculating for each word and for each of a plurality of possible typefaces a scaling factor for matching a typeface construction of the word to the size of the word in the scanned electronic care plan document. The OCR technique may then be used to analyze the variations of the scaling factors for a particular typeface and identify whether the typeface is a good fit for reconstructing a plurality of the words. Other known OCR techniques may be used however to convert one or more care plans into a digital format.

Once the care plans are in a digital format, at step 915 the individual care plan tasks may be identified and or modified by a user. According to one example, the HMS (100) identifies each word and compares each word with known words or terms that are used to describe common tasks within health care plans. For example, the HMS (100) may identify each word in the task “drink 8 glasses of water” of the first care plan 800, and compare one or more of the words (e.g., “Drink,” “8 glasses,” “glasses,” and or “water”) of the task with a plurality of known system tasks such as (“User action,” “64 oz goal,” “Measurement type [oz],” “Nutritional tag”), respectively.

When a number of compared words match, the care plan text may be identified as a care plan task. Also, after the text has been identified at step 915, using the computer connected to the server system (105) described above, a user may use a keyboard or other input device to correct or modify care plan task content if necessary.

Once the care plans tasks have been identified at step 915, at step 920 the HMS (100) determines if the tasks are in a standardized form. As described above, a task will be in a standard format if the task is in format consistent with the system's (100) task format settings (not shown). The system's task format settings may be stored in the HMS (100) database memory (135), and later accessed by the HMS (100). The task format settings may also be predefined or modified by a user of the HMS 100 such as a physician or authorized family member.

The task format settings also include settings related to the preferred units of measurement for converting quantitative data, preferred language information, and or care plan task content association. According to the present disclosure, task content association settings are settings used by the HMS (100) for determining whether to associate content with a care plan task during step 940 (discussed below).

In one example, the HMS (100) determines at step 920 that one or more tasks are not in a standardized form. In this example, a user may have preset or modified the task format settings to indicate that the care plan tasks are to be formatted using the metric system. Given this example, the HMS (100) at step 925 will access the task format settings, determine that care plan tasks are to be formatted using the metric system, and convert the task in the first care plan 800 from “ounces” of water to “liters” of water. As another example, the settings may be modified to allow logging data in one format, and viewing the log in a different format. This is especially useful in situations where, for example, a patient may want to log their weight in pounds, but the physician prefers to view the data in kilograms.

In another example, considering the task format settings indicate that care plan tasks are to be in a different language. According to the present disclosure, the preferred language may be set by the user in the task format settings. One reason why language formatting settings can be set by a user is because some patients may visit physicians in other geographical locations, often times receiving health care plans in languages other than the language the patient understands and communicates with. In this case, although a care plan may be received in a different language, the care plan may be translated into a preferred language during care plan standardization.

Again referring to the first care plan (800), if the user in the example above has set the language in the task format settings to Spanish, the HMS (100) at step 925 will access the task format settings, determine that care plan tasks are to be formatted in Spanish, and convert the care plan tasks from English to Spanish. Any language translator known in the art may be used for this conversion process.

Referring now to step 930, the HMS (100) may determine that input is necessary in order to complete the digitization process. In one example, some of the tasks to be performed by a patient may be based on certain feedback received from the patient. For example, the second care plan (805) includes the task, “Exercise: Pilates for twenty minutes.” However, the task itself may exist in response to a questionnaire that had previously asked the patient about the kinds of exercises the patient typically likes to do.

Other examples may be that a patient's health condition at the time of care plan creation may be different than the patient's health condition at the time of care plan normalization. For example, the patient may have previously given feedback that the patient was no longer in pain. The patient however may have given feedback incorrectly, due to not understanding a question inquired by a physician or the questionnaire in general.

In one example, the HMS (100) will prompt a user and or patient for input if the HMS (100) determines that user input may be necessary. Again using the first care plan (800) for purposes of illustration, after identifying the name or types of blood pressure and diabetes medications in step 915, at step 935 the HMS (100) may prompt the user and or patient to select whether they have had adverse reactions to the medication types or dosages. If the user and or patient answers the prompt in the affirmative, the HMS (100) will flag the task related to directing the patient to take the medication.

Further, using another example, based on patient feedback, the physician may not have instructed the patient to take a certain medication for pain. This could occur for example if the patient has answered a prompt stating that the patient is not in pain. However, if the patient subsequently provides input to the system (100) that the patient's level of pain has later increased, the system (100) may flag the patient's care plan indicating that the patient is in pain now.

In this and other aspects of the system (100), by using an alert component, the system 100 will proactively alert/notify users such as nurses or physicians when this occurs. For example, the system (100) will alert a user and or flag the patient's care plan when certain situations arise, such as when the patient indicates to the system that the patient is in pain.

In this scenario, the system (100) may be modified to alert when input is received from the patient, or when user defined thresholds have been reached relative to (levels of pain, etc.), side effects from medications, or in response to vital readings such as increased blood pressure, temperature, pulse, etc. Furthermore, the system (100) may be modified to alert due to a specific input by the patient to the system such as when the patient inputs an emergency response code like “HELP,” “911,” etc.

The alert component of the system (100) can be applied to any task type within the system (100), and the alert component may be modified by users having permission to the patient's portal. For example, if the physician or other user is monitoring the patient's care plan and receives an alert, the user may update the care plan accordingly e.g., to include one or more tasks directing the patient to take a certain medication for pain, call for help, etc.

Referring now to step 940, after processing the input determination at step 930, if the task format settings discussed above in step 925 indicate that informational content is to be associated with one or more of the tasks, at step 940 the HMS (100) will locate and associate content with one or more of the care plan tasks (e.g., information about the exercises, food, medicine, etc. involved in the task) and if related content is found, associate the content with those tasks.

The HMS (100) will first determine that associated content exists. For example, after identifying the tasks in the first or second care plan (800 or 805) the HMS (100) will query database (135) for key words similar to words identified in the one or more tasks described in step 915. If one or more documents or content having a threshold number of the identified words exists in the database (135), the HMS (100) will create a link (e.g., hyperlink) to that content and append the link or the document to the care plan having that task. The HMS (100) may additionally query content using the internet or other external resource (301).

In one example implementation of the above process at step 940, the HMS (100) may send a search query from the server system (105) to a web search engine server with a server system (105) search index attached to the search query. The search query will contain a list of key words or phrases related to each task, and will report back to the server system (105) the results of the search.

For example, referring to the diabetes medication in the first care plan (800), the HMS (100) may send a search query to a web search engine server to locate key words similar to the name of the diabetes medication. If any results matching the name of the diabetes medication are returned, the HMS (100) will associate the results (i.e., link to an article, website, etc.) with the task.

In another example referring to the second care plan (805), using a similar process, the HMS (100) may associate information related to the benefits of Pilates exercises, etc. Other content association methods may also be used, such as associating metadata with one or more tasks. The associated metadata can be the frequency that the task is to be performed, the time of day that the task is to be performed, and when the task will expire and will no longer need to be performed. Further, the metadata can be associated educational content, the type of the task (e.g., exercise based or nutritional based), the expected response (e.g., oz, lbs., etc.), or the alert thresholds described above.

In one example, content metadata may be associated with a care plan or care plan tasks using a document processing system that allows embedding metadata in digital documents, or other document processing systems known in the art. Using this example, and referring to the task instructing a patient to take diabetes medication in the first care plan (800), instead of associating a link to an article or information associated with the diabetes medication, the content and or link may be embedded in the care plan document as metadata.

At step 945, the HMS (100) classifies tasks that are in a common digital format and that have been standardized. Although the illustrations above may have involved first digitizing and standardizing the first and second care plans, if the care plans are initially in a common digital form (i.e., the “YES” path through step 905) and are initially in a standardized form (i.e., the “YES” path through step 920), the HMS (100) will classify the care plans at step 945.

The HMS (100) classifies tasks by associating with them one or more tags. The tags that are used to classify the tasks are independent of the care plan and the metadata associated with each task such as the educational content, the type of the task, etc. as described above, and instead exist to enable a programmatic approach to standardizing and assembling care plans from the system's (100) perspective.

In one example, during classification, a tag may be metadata that the HMS (100) will use to more readily interpret care plan tasks. For example, one or more tags may be assigned to a care plan task by using the task terms that were identified in step 915. The tags may be embedded within the care plan using the document processing settings described in reference to step 940 above.

Using the first care plan 800 as an example, one or more identified words may be associated with predefined HMS (100) tags. For example, one or more words of the task “drink eight ounces of water” of the first care plan 800 may be identified at step 915. These identified words are used during classification at step 945 by associating one or more task words with metadata. The metadata may be descriptive in nature, and may describe the task as generally related to instructing a patient to drink some amount of liquid.

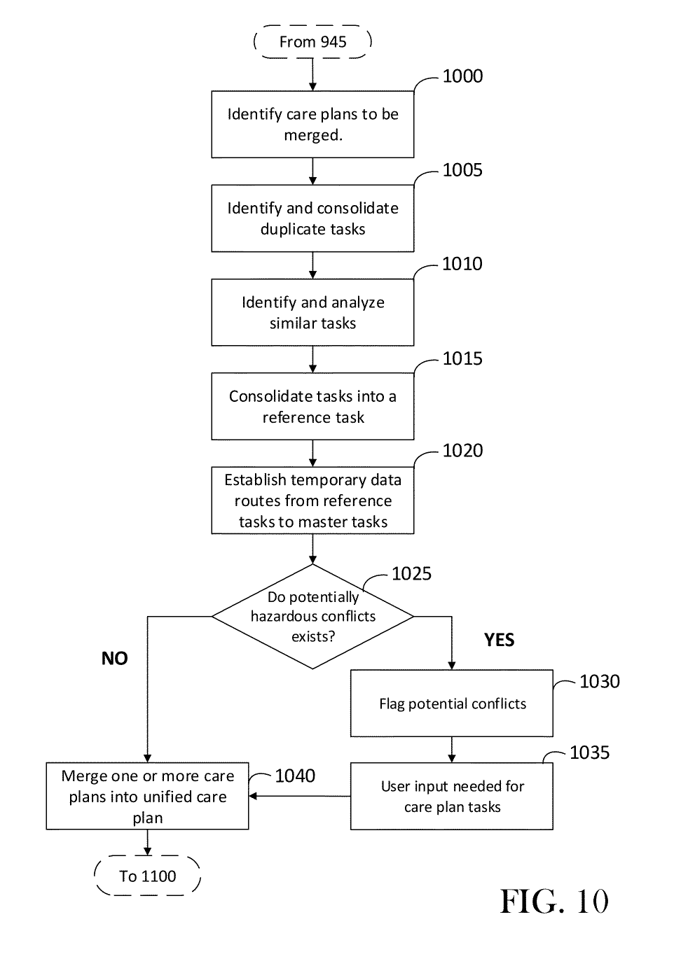

After the digitization process of FIG. 9, as shown in the flow diagram of FIG. 10, the HMS (100) will unify the one or more care plans into a single unified care plan. The unification process first begins by removing duplicate tasks. Because task titles may be in different languages or written in a different way e.g., “Drink Water” vs. “Drink 48 oz of Water,” the system strongly relies on the tasks' meta data. For example, task titles that have the same fingerprint i.e., title, type, format, and tag are unified into one. However for tasks that are not exact, yet closely related e.g., “Drink Water” vs. “Drink 48 oz of Water,” the system will prioritize the tasks in the order of tasks having defined alert thresholds, goal-oriented tasks, and tasks that request ‘structured’ data responses e.g., logging 48 oz of water is better than a yes/no response.

In another example, a duplicate task may be a task that is listed in more than one care plan, or listed more than once in the same care plan. In this example, the duplicate tasks may have been identified during step 915. However, using document processing applications described below, the HMS (100) will remove these duplicates from the unified care plan.

For removing duplicate tasks, the system (100) at step 1000 first inspects a patient's profile and identities which care plans are being merged. The system will analyze a patient's profile for care plans that have been selected for merging. Care plans may be selected for merging by a user of the system at digitization.

After the system identifies the care plans to be merged, at step 1005, the system (100) removes the purely duplicate master tasks and creates one reference task for the duplicates. In order to remove the pure duplicates, a simple character search may be performed on the master task strings for each of the care plans. Character string search and recognition can be performed using character recognition document processing applications such as those used in Microsoft Word or Adobe document processing systems as known in the art. Once the duplicate character strings have been identified at step 1005, they may be consolidated by the system (100) into a single reference task.

Also at step 1010, the system (100) identifies tasks that aren't exact duplicates, but are similar, based on their meta data and analyzes the metadata to determine which tasks will provide the most data. For example, given three similar tasks in three different care plans: “Drink water,” “Drink 48 oz of water,” and “Drink 64 oz of water.”

If the metadata associated with the first task “Drink water” is directed to a simple (True/False) query of the patient e.g., merely prompting the patient to answer whether or not the patient has taken water for the day, that task may not will not be considered by the system as providing more data than e.g., the second task “Drink 48 oz of water,” having metadata that requires a numeric response from a patient e.g., prompting the patient to enter the amount of water the patient has taken given a 48 oz goal.

Likewise, the third task “Drink 64 oz of water” may be considered to provide the most data than both the first and second tasks if the third task requires a numerical response (as described above), and also provides educational content to a patient such as information related to why drinking water is important given the patient's diagnoses. After the system (100) identifies and analyzes the tasks that are similar at step 1010, the system (100) consolidates the similar tasks into one reference task at step 1015. For example, the consolidated task may state, “Drink 64 oz of water today,” having metadata that requires a numeric response given 64 oz goal and have associated educational content.

After consolidating the duplicate tasks, the system (100) at step 1020 establishes data links between the reference tasks, the original master tasks, and originating care plan for interoperability across disparate systems. For example, a user that provides the first care plan may check the patient's portal (125) to see that the patient drank water. Because, that particular care plan's task “Drink water” was consolidated into the task, “Drink 64 oz of water today,” the system will include additional notes stating that the patient drank an amount of 64 oz of water. The users who administered the second and third care plans will obtain similar information through the patient's portal (125).

Once all existing task duplications have been determined and removed and or flagged, the HMS (100) will determine if there exist any task conflicts at step 1025. Task conflicts may be hazardous to a patient, or may simply be conflicting instructions that are impractical for a patient to execute.

Medication based tasks are queried against a 3^{rd} party database of known reactions to identified patient risks. Further, in other cases care plans may have conflicting advice given surrounding a patient's treatment. For example, a diabetic patient suffering from knee pain may have his chronic disease coach suggest he run daily, while his physical therapist suggest he only walk and do light stretches. In either case, care plans having conflicts are flagged for clinical review and resolution.

For example, considering different physicians give a patient the first and second care plans (800 and 805) described above. At step 1025 the HMS (100) will compare each identified task within each care plan, and also compare each identified task with the tasks that have been identified within other care plans (if multiple care plans are being merged) for determining conflicts.

In one illustration, the HMS (100) at step 1025 will compare the types of diabetes and blood pressure medications the patient has been directed to take per the first care plan (800). The HMS (100) may then query the database (135), care plan conflict data (310) and or other external resource (301) (such as the internet, etc.) using a search query or other method, and determine whether or not potential conflicts exists with taking both of these medications.

In another example, the HMS (100) may compare the identified task “walk three miles” in the first care plan (800) with the identified task “Exercise: Pilates for twenty minutes” in the second care plan (805). If the instructed times for exercising are at the same time (e.g., if the care plans direct the patient to do both tasks at 1:00 pm), the HMS (100) may detect the times as being the same, and flag one or more of the tasks as having a conflict at step 1030.

If the tasks identified above are flagged as having a conflict, the HMS (100) may indicate to the user that there exists a conflict in the unified care plan e.g., the HMS (100) may indicate a conflict next to the task “walk three miles,” “***conflict with Pilates exercise at 1:00 pm***.” Upon noticing the conflict, a user (preferably a physician or health care provider) may modify the unified care plan (as discussed below) to remove the conflict.

Once all existing conflicts have been determined and flagged, or if the HMS (100) queries and finds that no potential conflicts exist, the HMS (100) will merge the one or more care plans at step 1040. In order to merge the care plans at step 1040, the HMS (100) will reorganize each task from the one or more collective care plans and any reference tasks into a single care plan. The HMS (100) may reorganize tasks using the document processing application described above, which may be used to modify or extract the task data including associated content, classification tags, and or other metadata for each of the care plan tasks, and append the task data to a single care plan document.

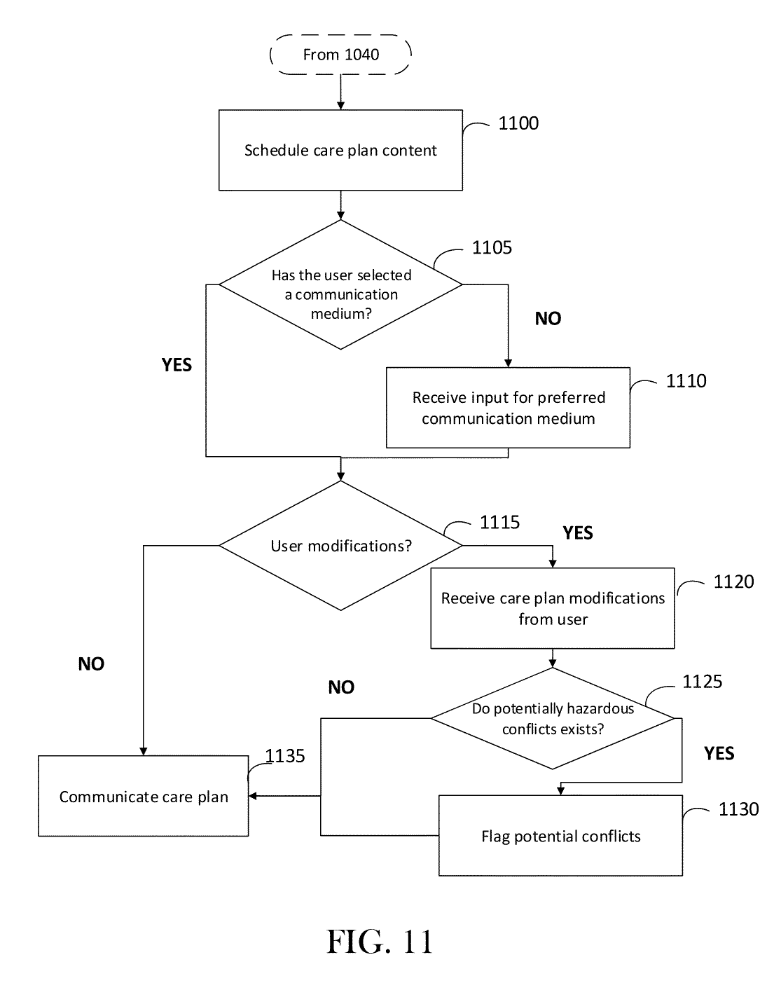

Referring now to FIG. 11, once the one or more care plans have been unified, the unified care plan will be communicated to a patient. At step 1100, the care plan content to be communicated will first be scheduled. In one example, the unified care plan at step 1010 will include all tasks associated with a physician's instructions. By scheduling the content of the unified care plan, the care plan tasks will be delivered to a patient on a scheduled basis.

For example, a unified care plan may contain a task directing a patient to “take cholesterol medication three times a day,” or “exercise regularly.” As these are general tasks, a patient may not know if taking the medication three times before breakfast would satisfy the first task, or if exercising for 30 minutes every month would satisfy the second task. Thus, the HMS (100) may take the tasks within the unified care plan and schedule the tasks so that scheduled care plans are delivered to the patient on a regular basis.

In one example, scheduling the tasks will be performed by the HMS (100) by using user defined settings. Stored in the database (135) or other memory within the server system (105), user defined settings indicate how general tasks are to be scheduled. For example, considering the task above requiring a patient to exercise regularly. The HMS (100) may identify this as a general task, and use the user defined settings to schedule the task.

Using this example, if the user defined settings indicate to the HMS (100) that the above task should be scheduled for directing a patient to exercise at least three times per week, the HMS (100) may schedule the patient's communicated care plan accordingly. The same user defined settings may apply for scheduling the time intervals for directing the patient to take medication. However, the system (100) may also obtain information regarding the type of medication and suggested times for taking the medication from the database (135), user, or other resource such as the internet as described above.

Referring to step 1105, after the care plan content has been scheduled, the HMS (100) determines whether or not a user has selected a medium for communication. Care plans are communicated, including any associated metadata, using at least one communication medium (e.g., email, text messaging, web portal, interactive video, or through the use of any other digital communication device). In one example, if the HMS (100) determines that no communication medium has been selected, the HMS (100) will prompt a user and or patient in order to receive input regarding the selection of one or more communication mediums at step 1110. This input may include the communication medium (i.e., email, text messaging, etc.) along with the associated communication medium contact information such as an email address or phone number.

After one or more communication mediums have been selected, at step 1115 the HMS (100) may again prompt the user for any additional modifications of the care plan before the HMS (100) communicates the care plan to the patient. In one example, if the user selects that the care plan is to be personalized, at step 1120 the user will be given the opportunity to modify one or more of the contents, color, font, contrast, sound, orientation, metadata, or style associated with the unified care plan.

The HMS (100) will use the user's input to modify document processing settings associated with the document processing system described above. For example, if the settings were modified to indicate that the color of the care plan should be changed from white to red, the document processing system will change the color of the care plan accordingly before the HMS (100) communicates the care plan to the user. The metadata such as sound, duration, and frequency associated with a reminder or associated content may be modified in a similar manner.

If however, the care plan to be communicated has been personalized by the user at step 1120, the care plan at steps 1125-1130 will again identify potential conflicts and flag the potential conflicts if any exist. Steps 1125-1130 are similar to steps (1000-1005) discussed above, and serve to flag conflicts that may have been introduced by a user during care plan personalization at step 1120. Once all conflicts have been identified and flagged, or if the care plan has not been personalized by the user (see “No” path through step 1115) the care plan will be communicated to a user and or patient using the selected communication medium.

For example, if a user at step 1110 has selected to receive care plan communication through email, the HMS (100) will send the care plan to the user's email address. In another example, if a patient at step 1110 has selected to receive communication through the web portal (125), the HMS (100) may host a webpage using the server system (105), allowing the patient to log into and access care plan information stored on the HMS (100) database (135) or other server system (105) memory. Using this example, the HMS (100) may communicate a website link or universal record locator (URL) with the user via email or other method so that the patient may access the care plan information.

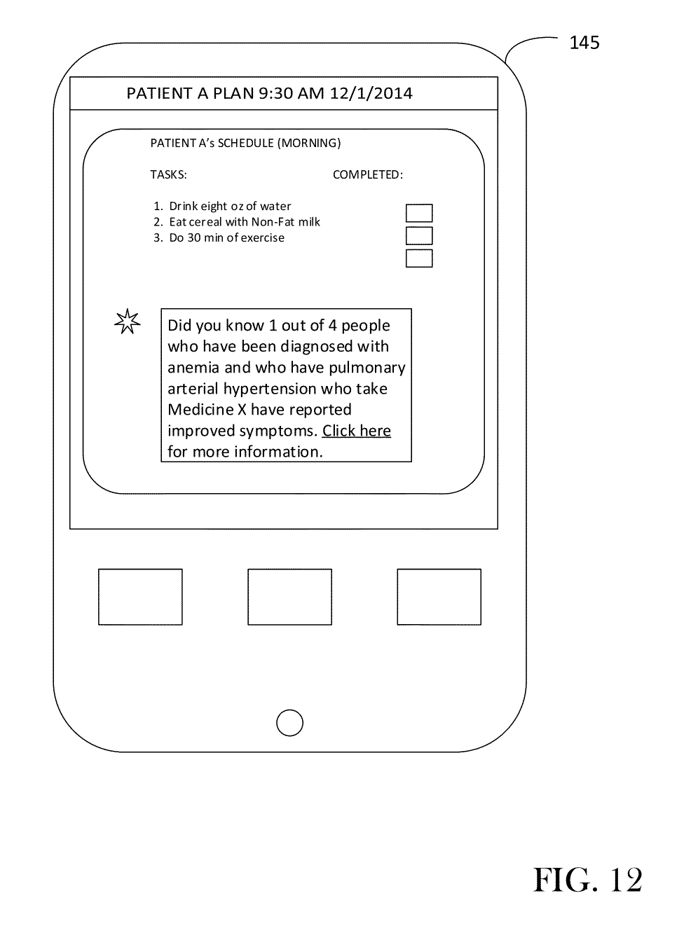

FIG. 12 illustrates an example unified care plan that has been accessed through a web portal (125) using a client device 145 according to the present disclosure. As shown, the client device 145 may be a digital device such as a PDA, cellular phone, or other device. As described above, a user or patient may use a client device 145 to access one or more care plans through a web portal (125). Also, the client device 145 may display the contents of a care plan using a GUI interface. In this example, through the GUI interface a user and or patient may access content related to a care plan, modify the care plan, and or otherwise give input through the GUI interface.

Also, for some patients, because the severity of their disease or treatment can make simple physical and/or mental activities nearly impossible, the system (100) may allows a user such as family member or friend to log any information on behalf of the patient using the patient's web portal or dashboard (125). In other cases, the family member or friend can be allowed to monitor their loved one's medical information from across the globe.

As shown in FIG. 12, the GUI interface indicates that Patient A's care plan currently directs Patient A to perform three tasks on the morning of Dec. 1, 2014. Also as shown are input boxes that may be checked at the time each of the tasks have been completed. Checking the boxes may provide feedback to the HMS (100) regarding the patient task updates. For example, if the box associated with a first task does not get checked, the care plan may send a reminder regarding that task in the afternoon and or evening. However, if a task is checked as completed, the database (135) will update the care plan scheduled content and no reminder will be sent.

As another example, as shown at the bottom of the client device 145 display in FIG. 12, associated content as discussed above may be presented on the client device 145. The associated content may be educational in nature and may contain links to other resources that may be located on other servers such as web servers, etc., external resources (300), or databases (135).

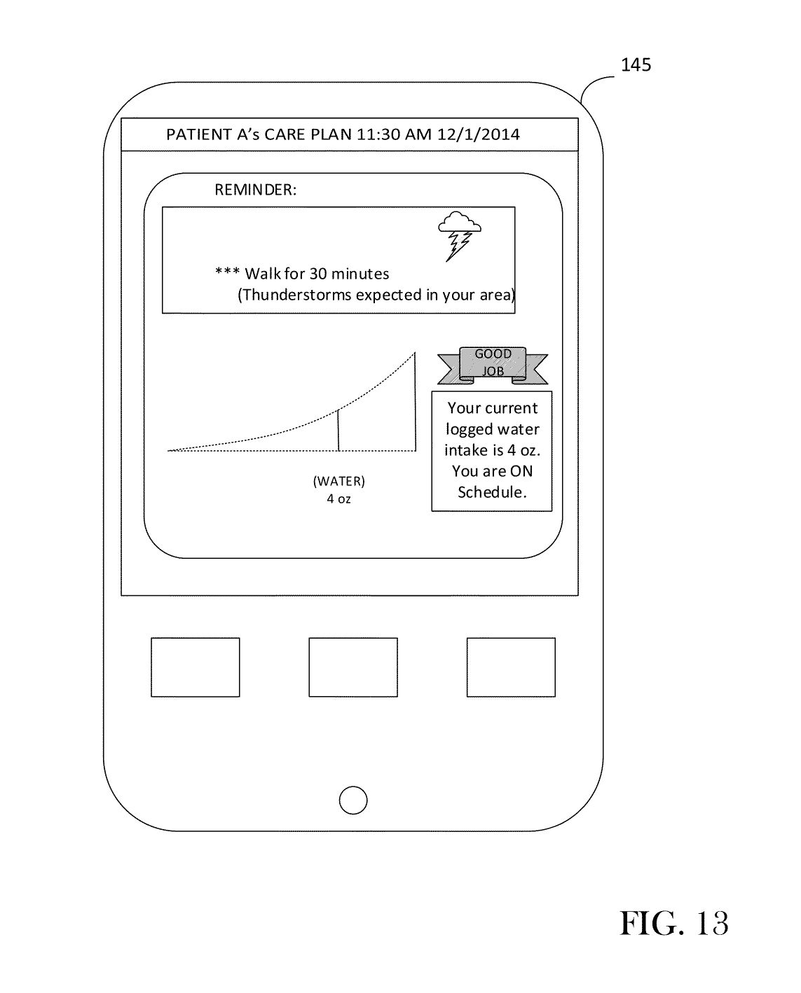

Referring now to the example in FIG. 13, a reminder is shown reminding Patient A to walk for 30 minutes, or to remind a user such as a health care professional or loved one that Patient A has not walked for 30 minutes that day. In another example, as shown in the reminder window of the client device 145 in FIG. 13, a weather warning or other warning may be shown. Weather, road conditions, and potentially hazardous patient health information may be obtained from the client device 145, the server system (105), internet, or other resource described herein.

Also as shown in the bottom of the client device 145 display in FIG. 13, the GUI interface may allow the user and or patient to input progress information such as how much water intake the patient has recorded for the day. In yet another example, the system (100) may give positive feedback through the GUI interface, or other communication medium, based on care plan feedback received from one or more users and or patients.

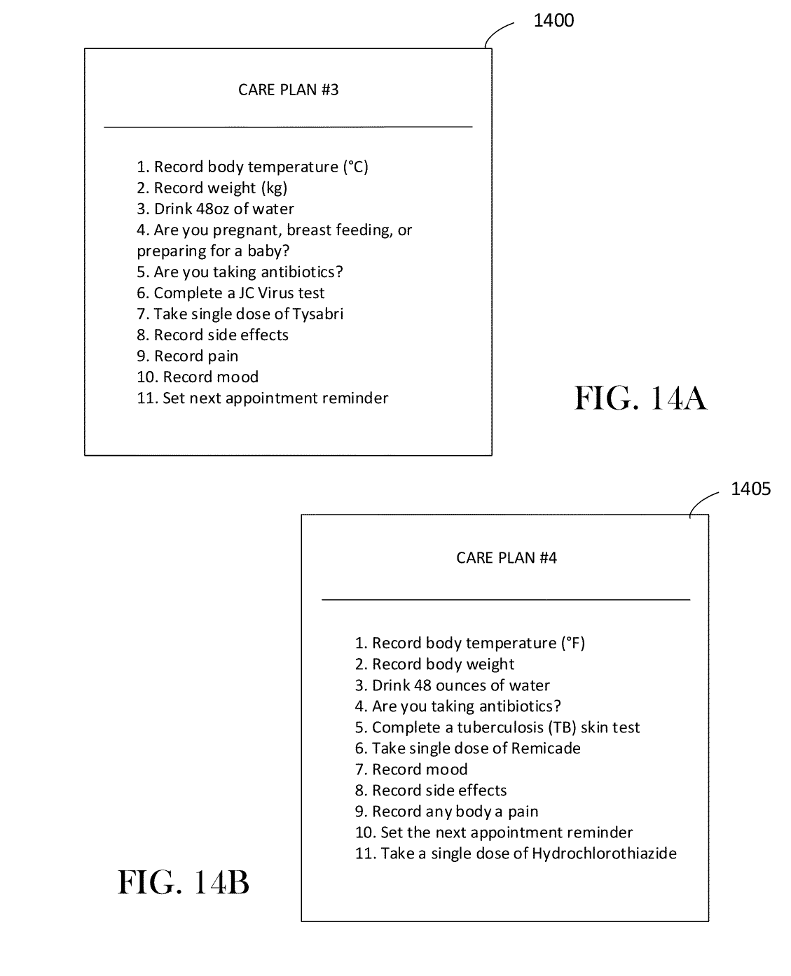

Referring now to FIGS. 14A-14B, additional examples of health care plans are illustrated according to the present disclosure. As shown, the example care plan 1400 shown in FIG. 14A is for a patient who has been directed to take the medication Tysabri. The drug Tysabri® (natalizumab) is a prescription medicine used to treat patients having relapsing forms of Multiple Sclerosis (MS). Also, the example care plan 1405 shown in FIG. 14B is for patients who have been directed to take the medication Remicade®, which is used to treat Crohn's Disease and other gastrointestinal disorders.

The operation of flow charts of FIGS. 9, 10, and 11 using the above care plans is as follows. In a first example using the care plan 1400, once the HMS (100) has been executed on the server system (105), the process of normalizing health care plans begins by a user accessing the system and inputting one or more of the care plans (1400, 1405) into the HMS (100) as shown at step 900. A user may access the HMS (100) either through a computer or workstation directly communicating with the server system (105), or through the internet (e.g., through a web portal) using one or more client devices (145). As described above however, it is not necessary for a user to input the care plans, as the system (100) can automatically import the care plans/discharge notes into the system (100) by integrating the HMS (100) with the patient's EHR such as Epic or Allscripts.

After accessing the HMS (100) and inputting or importing the care plan 1400, care plan 1400 is automatically converted into a format suitable for electronic document exchange, such as portable document format (PDF), Microsoft Word document (.doc), or other exchange format. Once in a suitable format for exchange, the care plan 1400 is uploaded to the HMS (100) for processing. In this aspect, the HMS (100) can allow the user to browse for additional health care plans and upload them to the HMS (100) if desired.

After the care plan 1400 has been uploaded into the HMS (100), at step 905 the HMS (100) determines if the care plan is in a common digital format that is interpretable by the HMS (100). At step 905, the system (100) determines that the care plan 1400 is not in a digital format. At this point, a conversion process is initiated at step 910 and is used to convert the non-digital content of the care plan 1400 into a digital form. In order to do so, an adaptive optical character recognition (OCR) application is executed and performs character recognition on the care plan 1400 to convert the care plan 1400 into a digital format.

Once the care plan 1400 is in a digital format, at step 915 the care plan tasks e.g., tasks 1-11 of care plan 1400 are identified and or modified by a user. The HMS (100) identifies each task by identifying each word and comparing each word with known words or terms that are used to describe common tasks within health care plans. Once the care plans tasks have been identified at step 915, at step 920 the HMS (100) determines if the tasks are in a standardized form. Because the system (100) recognizes that a task will be in a standard format if the task is in format consistent with the system's (100) task format settings, the system at step 920 retrieves the task format settings from the HMS (100) database memory (135).

After determining that the task format settings sets units of measurement for converting quantitative data to Fahrenheit (° F.) for temperature and pounds (lbs) for weight, at step 920 that tasks 1 and 2 of care plan 1400 are not in a standardized form. After making this determination, the HMS (100) at step 925 will convert the values for temperature and weight of tasks numbered 1 and 2 to Fahrenheit (° F.) and pounds (lbs), respectively. The system (100) at step 920 will also convert future values input in response to the tasks as Fahrenheit (° F.) and pounds (lbs), respectively.

Referring now to step 930, after standardizing the care plan 1400 tasks the HMS (100) determines that no input is necessary in order to complete the digitization process. At step 940, based on the task format settings discussed above in step 925, the system determines that informational content is to be associated with task 7. After making this determination, the HMS (100) determines that associated content exists by performing a query of the database (135), internet, and external resources (301) for key words that are similar to words identified in task 7. The system further locates content that has a threshold number of identified words related to the medication Tysabri in database (135), creates a link (e.g., hyperlink) to that content, and appends the link or the document within the metadata of task 7.

After associating content with task 7, at step 945 the HMS (100) determines that all of the tasks in the care plan 1400 are in a common digital format and are in a standardized form. At step 945 based on the terms identified in task 3 of care plan 1400, the HMS (100) classifies task 3 of care plan 1400 “Drink 48 oz of water” by associating metadata with the tags “nutritional,” “yes/no,” “water intake.” The system classifies the remaining tasks of care plan 1400 similarly, by associating one or more tags with each of the tasks based on identified terms of the task. As discussed above, the tags are independent of the care plan metadata associated with each task such as the associated content, the type of the task, etc.

After the digitization process illustrated in FIG. 9, referring to FIG. 10, the HMS (100) unifies care plan 1400. The unification process begins by removing duplicate tasks. The system (100) at step 1000 first inspects a patient's profile and identities care plan 1400 is the only care plan to be merged. After identifying the care plans to be merged, at steps 1005 and 1010 the system (100) determines that there aren't any pure duplicate or similar tasks, and skips the consolidation process at step 1015.

The system (100) at step 1020 continues by determining that there aren't any consolidated reference tasks and proceeds to step 1025 to determine if task conflicts exists. In determining conflicts, the system (100) at step 1025 compares the types of medications the patient has been directed to take per the care plan (1400), and queries the database (135), care plan conflict data (310), and or other external resources (301) (such as the internet, etc.) using a search query as described above to determine if there are any conflicts. At step 1025, the system determines that the drug Tysabri® (natalizumab) is a prescription medicine used to treat patients having relapsing forms of Multiple Sclerosis (MS), and is not in conflict with any other prescribed drugs in the care plan 1400.

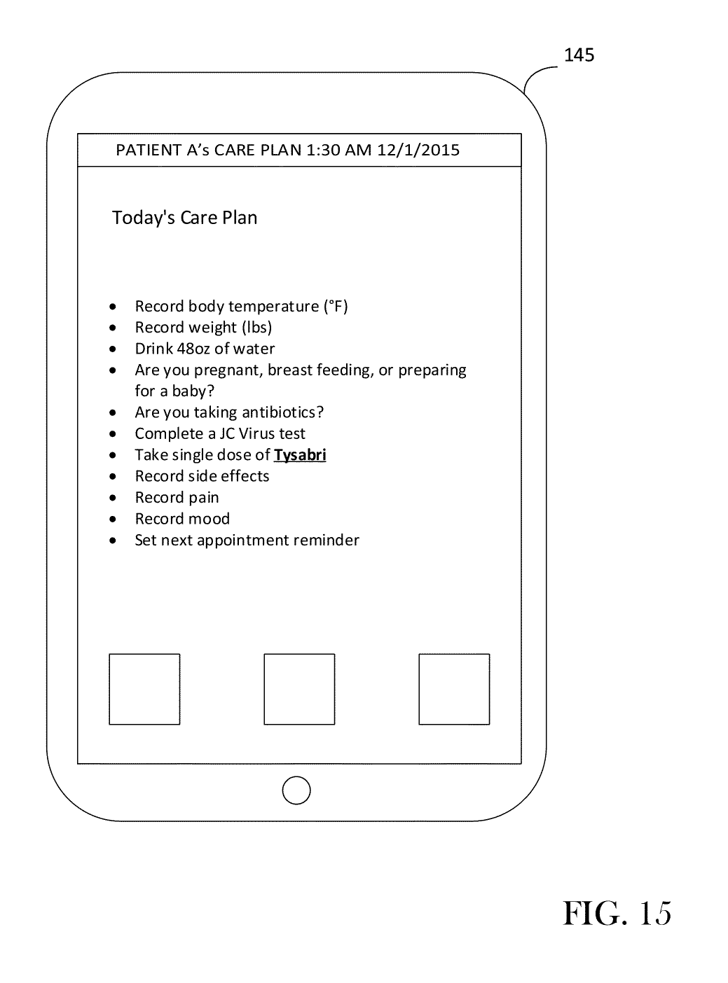

After the HMS (100) queries and determines that no conflicts exist, the HMS (100) merges care plan 1400 at step 1040. To this end, using the document processing application described above, the HMS (100) reorganizes each task in care plan 1400 with reference tasks. However, because the system (100) did not identify any reference tasks above at step 1025, the HMS (100) continues by appending the task data to a single care plan document as shown in reference to FIG. 15, and as discussed below.

Referring now to FIG. 11, as described above, once the system (100) merges the care plan 1400 into a unified care plan (see FIG. 15), the unified care plan will be communicated to the patient and or user. However before being communicated, the system (100) will schedule each task within the care plan. As described above, by scheduling the content of the unified care plan, the care plan tasks will be delivered to a patient on a scheduled basis.

For example, the unified care plan of FIG. 15 may contain a task directing a patient to “Take a single dose of Tysabri.” At step 1100, the system reads the user defined settings stored in the database (135) or other memory within the server system (105), and determines the scheduling preferences for the task instructing the patient to take the medication Tysabri to be once per month on the first day of the month. The HMS (100) subsequently schedules this task to prompt the user to take the medication on the first day of each month.

After each of the tasks have been scheduled at step 1100, at step 1105 the HMS (100) determines whether or not a selected a medium for communication has been selected. Using this example, because a communication medium has not been selected, the HMS (100) prompts the user and or patient to input a preferred communication medium i.e., email, text messaging, web portal (125) etc., as described above.

After receiving input that the communication medium has been selected as web portal (125), the HMS (100) at step 1115 prompts the user for additional modifications of the care plan before communicating the care plan to the patient. Again using this example, the user selects at step 1120 that the unified care plan of FIG. 15 is to be personalized by delineating each task with bullets instead of numbering each task. The user's input is used to modify the document processing settings associated with the document processing system described above, and HMS (100) at step 1135 will modify the unified care plan based on the updated settings before communicating the care plan to the user.

After personalization however, at step 1120 the care plan of FIG. 15 again identifies potential conflicts and flags the potential conflicts if any exist. After determining at step 1125 that no hazardous conflicts are present, or that the care plan has not been personalized by the user (see “No” path through step 1115) the system (100) communicates the care plan by hosting a webpage at step 1135 using the server system (105), that allows the patient to log into and access the care plan information shown in FIG. 15.

Referring now to FIG. 15, an example of a unified care plan based on the care plan of FIG. 14A is illustrated. The unified care plan is accessed through a web portal (125) using a client device 145 as discussed above. The client device 145 may be a digital device such as a PDA, cellular phone, or other device. The client device 145 may display the contents of a care plan using a GUI interface, where the patient and or user may access content related to a care plan, modify the care plan, and or otherwise give input through the GUI interface.

As shown in FIG. 15, the GUI interface indicates that Patient A's unified care plan directs Patient A to perform tasks in the afternoon of Dec. 1, 2015. Also, using a touch screen display, as is known in the art, each task may be accessed by touching that task on the display of the client device 145 to either provide input to the system (100) regarding that task, such as when the task has been completed by the patient. Also as shown, the system (100) has standardized the temperature and weight values in the unified care plan from Celsius (° C.) and Kilograms (kg), as shown in care plan 1400 of FIG. 14A, to Fahrenheit (° F.) and pounds (lbs), respectively. Also, the system (100) has associated content with the task directing the patient to take a “single dose of Tysabri.” For example, by touching or selecting the underlined word “Tysabri” (e.g., the hyperlink) in the unified care plan, the associated website containing information related to the medication can be accessed by the user and or patient.

Now that an example of the system and method for normalizing and communicating care plans using just a single care plan has been described, an example of the system and method using both the third and forth care plans, 1400 and 1405, respectively, will now be described. As discussed above with reference to FIG. 14A, once the HMS (100) has been executed on the server system (105), the process of normalizing health care plans begins with accessing the system and inputting or importing care plans 1400 and 1405 into the HMS (100).

After accessing the HMS (100) and inputting or importing the care plans 1400, 1405, as described above, the care plans are automatically converted into a format suitable for electronic document exchange. Once in a suitable format for exchange, the care plans 1400 are uploaded to the HMS (100) for processing.

After the care plans 1400, 1405 have been uploaded into the HMS (100), at step 905 the HMS (100) determines if each care plan is in a common digital format that is interpretable by the HMS (100). At step 905, the system (100) determines that the care plan 1400 is not in a digital format, but that care plan 1405 is in a digital format. At this point, a conversion process is initiated at step 910 and is used to convert the non-digital content of the care plan 1400 into a digital form. The system at step 910 then executes an adaptive optical character recognition (OCR) application and performs character recognition on the care plan 1400 to convert the care plan 1400 into a digital format.

Once the care plan 1400 is in a digital format, as discussed in the above example using only care plan 1400, at step 915 the care plan tasks of both care plan 1400 and 1405 are identified by the system (100). Once the care plans tasks have been identified at step 915, at step 920 the HMS (100) determines if the tasks are in a standardized form, and retrieves the task format settings from the HMS (100) database memory (135) in order to make the determination.

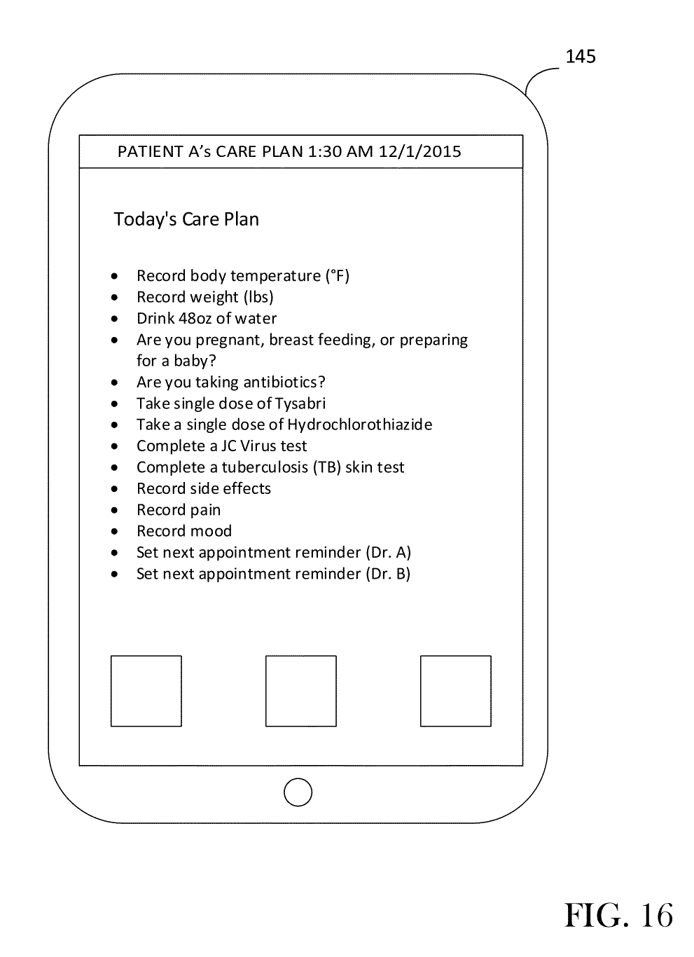

After determining that the task format settings require units of measurement for converting quantitative data to Fahrenheit (° F.) for temperature, and pounds (lbs) for weight, at step 920 each task of care plans 1400 and 1405 are evaluated. After making the determination, that at least some of the tasks are not in a standardized form (i.e., not specific to Fahrenheit (° F.) and pounds (lbs), for temperature and weight, respectively), the HMS (100) at step 925 converts the temperature and weight values of the tasks to Fahrenheit (° F.) and pounds (lbs), as shown in the unified care plan of FIG. 16.

Referring now to step 930 of FIG. 9, after standardizing each of the care plan's (1400, 1405) tasks the HMS (100) determines that user input is necessary in order to complete the digitization process. As described above at step 915, the system (100) identifies tasks by identifying each word of the tasks and comparing each word with known metadata tags or terms that are used to describe common tasks within health care plans. In this example, the system (100) identifies the task in care plan 1405 that directs the patient to complete a Tuberculosis skin test. For example, the term “Tuberculosis” of the care plans is compared with the metadata tag “TB skin test” saved in the database (135), and is identified as a Tuberculosis test.

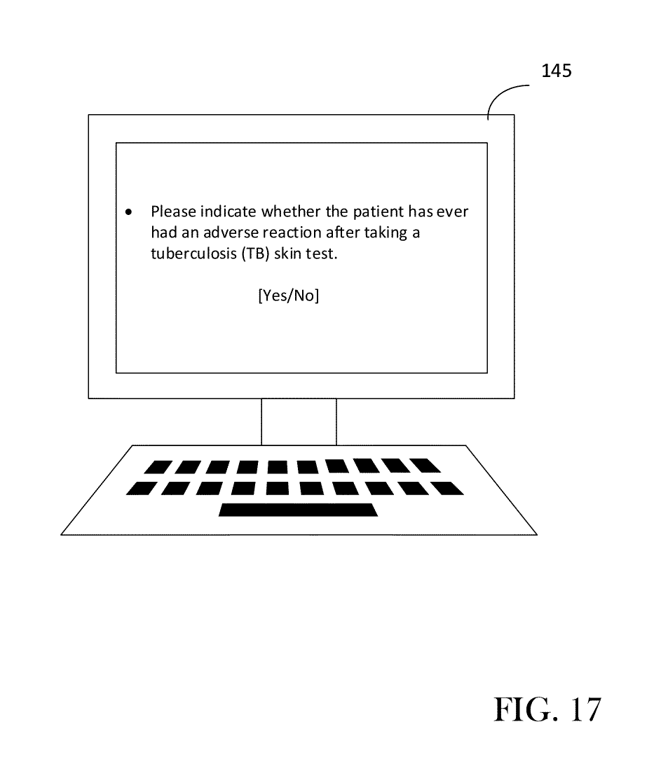

At step 930 of FIG. 9, the metadata associated with this task directs the system (100) to display a prompt to the user requesting input regarding whether the patient has previously had an allergic reaction after receiving skin tests of this type (see FIG. 17). As described above, prompts may be displayed and input received via the HMS (100) either through a computer or workstation directly communicating with the server system (105), or through the internet (e.g., through a web portal) using one or more client devices (145). After receiving the user's response that the patient has not had an allergic reaction to this test, the system (100) refrains from flagging the task for user review, and continues to step 940.

At step 940, based on the task format settings discussed above in step 925, the system determines that informational content is to be associated with task 7 of care plan 1400 “Take single dose of Tysabri,” and task 6 of care plan 1405 “Take single dose of Remicade.” After making this determination, the HMS (100) determines that associated content exists by performing a query of the database (135), internet, and external resources (301) for key words that are similar to words identified in each task. The system further locates content in database (135) that has a threshold number of identified words related to the medications Tysabri and Remicade, creates a link (e.g., hyperlink) to that content, and appends the link or the document within the metadata of each respective task.

After associating content with each task, at step 945 the HMS (100) determines that all of the tasks in each care plan 1400, 1405 are in a common digital format and are in a standardized form. At step 945 based on the terms identified in task 3 of care plan 1400, the HMS (100) classifies task 3 of care plan 1400 “Drink 48 oz of water” by associating metadata with the tags “nutritional,” “yes/no,” and “water intake.” The system (100) classifies the tasks of care plan 1405 similarly, by associating one or more tags with each of the tasks based on identified terms of the task. As discussed above, the tags are independent of the care plan metadata associated with each task such as the associated content, the type of the task, etc.

After the digitization process illustrated in FIG. 9, referring to FIG. 10, the HMS (100) unifies care plans 1400 and 1405 into one unified care plan. The unification process begins by first removing duplicate tasks. The system (100) at step 1000 inspects the patient's profile and identities two care plans (i.e., care plans 1400 and 1405) are to be merged. After identifying the care plans to be merged, at steps 1005 and 1010 the system (100) identifies the pure duplicate tasks at step 1005.

By parsing the character strings of the tasks in each care plan 1400, 1405, the system (100) identifies that the task “Are you taking antibiotics” exists in both care plans. The system also identifies the task “Record mood” as being similarly duplicated in each care plan. After identifying the pure (i.e., duplicate tasks), the system (100) consolidates the duplicate tasks by creating a single reference task for each of the tasks, using the character string of each of the tasks. For example, the four duplicates described above are replaced with two reference tasks having the character strings “Are you taking antibiotics” and “Record mood.”

However, the system (100) will not replace pure duplicate tasks in cases where the character strings of the tasks are the same, but the metadata of the tasks are different. For example, both care plans (1400, 1405) have the task “set next appointment reminder.” However, although each task will have the exact same character string during identification at step 915, due to the identified type of the task (e.g., “appointment modification”) the metadata associated with each task will be specific to each care plan. Such metadata will contain detail such as the physician associated with creating that care plan, etc.

As a result, after identifying the duplicate task “set next appointment reminder,” the system (100) will not consolidate the duplicate tasks by creating a single reference task for each of the tasks; instead, the system (100) will create both tasks in the final care plan as shown in FIG. 16. As shown in FIG. 16, each task may also have a suffix indicative of the task's respective care plans. For example, considering care plan #3 (1400) was created by the physician, “Dr. A,” the task that derived from care plan #3 (1400) will have a suffix indicating that the patient's reminder is to set an appointment with that particular doctor e.g., “Dr. A.” Likewise, the task deriving from care plan #4 (1405) will have a similar suffix.

At step 1010, the system (100) identifies tasks that aren't exact duplicates, but are similar based on task meta data. The system (100) identifies that the task “Drink 48 oz of water” in care plan 1400, and the task “Drink 48 ounces of water” in care plan 1405 share the similar metadata “nutritional,” “yes/no,” and “water intake.” Based on this analysis, the system (100) determines that the tasks are similar, and at step 1015 consolidates the task into a single reference task.

However, because the tasks are not exact duplicates, the system consolidates the tasks by determining which task will provide the most data. Because each of the above tasks will provide the same amount of data (i.e., in response to either task a yes/no response will be received, no informational content is associated with either task, etc.), the first task string processed by the system (100) will be used as the reference task (i.e., “Drink 48 oz of water”). The system processes the remaining similar tasks as described above, and continues to step 1020.

After consolidating the duplicate tasks, the system (100) at step 1020 establishes data links between each of the reference tasks, the original tasks, and originating care plan. At step 1025 the system determines if task conflicts exists. In determining conflicts, the system (100) at step 1025 compares the types of medications the patient has been directed to take per the care plans 1400, 1405, and queries the database (135), care plan conflict data (310), and or other external resources (301) (such as the internet, etc.) to determine if there are any conflicts.

At step 1025, the system determines that the drug Tysabri® (natalizumab), of care plan 1400 is a prescription medicine used to treat patients having relapsing forms of Multiple Sclerosis (MS), and is in direct conflict with the drug Remicade® of care plan 1405, that is used to treat Crohn's Disease and other gastrointestinal disorders. The system (100) further detects the task “take a single dose of Hydrochlorothiazide” and determines that the drug Hydrochlorothiazide is not in conflict with either of the drugs Tysabri® or Remicade®.

After the HMS (100) queries and determines that conflicts exist, the HMS (100) flags each task for review and after the conflict has been resolved by a user (i.e., doctor, nurse, etc.) the resolution will be reflected in the unified care plan (shown in FIG. 16). After the system (100) detects a conflict between the medications Remicade® and Tysabri® at step 1025 of FIG. 10, at step 1030 the system will flag each task which contains those drugs for review. After the tasks have been flagged, the system (100) at step 1035 will prompt the user for input related to the conflict, either through a computer or workstation directly communicating with the server system (105) as described above, or through the internet (i.e., through the patient's web portal).

When the system (100) prompts the user at step 1035, the user will provide input to the system (100) to resolve the conflict, either by selecting one of the conflicting medicines, changing a particular medication, or by removing all of the conflicting medicines from the care plans. In any of the above resolutions, the user will likely contact the physicians and or necessary parties before modifying care plans. At step 1035, the user provides input to the system to remove the task instructing the patient to take the medication and Remicade®. After the conflict has been resolved, the conflict resolution will be reflected in the unified care plan. As shown (shown in FIG. 16), the task related to taking the drug Tysabri® has been included in the unified care plan, while the drug Remicade® has been removed. Also as shown, the drug Hydrochlorothiazide has also been included in the unified care plan (FIG. 16), as it was not in conflict with the other medications.

After all conflicts have been resolved, at step 1040, using the document processing application described above, the HMS (100) reorganizes each task in care plan 1400 using the reference tasks and non-consolidated tasks. The HMS (100) continues by appending the task data to a single care plan document as shown in FIG. 16. Referring now to FIG. 11, as described above, once the system (100) merges the care plans 1400, 1405 into a unified care plan (FIG. 16), the unified care plan will be communicated to the patient and or user.

However, as described above with reference to the unified care plan of FIG. 15, before being communicated the system (100) will schedule each task within the care plan. By scheduling the content of the unified care plan, the care plan tasks will be delivered to a patient on a scheduled basis. After each of the tasks have been scheduled at step 1100, at step 1105 the HMS (100) determines whether or not a selected a medium for communication has been selected.

After receiving input that the communication medium has been selected as web portal (125), the HMS (100) at step 1115 prompts the user for additional modifications of the care plan before communicating the care plan to the patient. The system at step 1115 receives input from a user that additional modifications are not necessary, and at step 1135 the system (100) communicates the care plan by hosting a webpage using the server system (105), that allows the patient to log into and access the care plan information shown in FIG. 16.

Referring now to FIG. 16, an example of a unified care plan based on the merged care plans of FIGS. 14A and 14B is illustrated. The unified care plan is accessed through a web portal (125) using a client device 145 as discussed above. The client device 145 may be a digital device such as a PDA, cellular phone, or other device. The client device 145 may display the contents of a care plan using a GUI interface, where the patient and or user may access content related to a care plan, modify the care plan, and or otherwise give input through the GUI interface.

In this case, the screenshot was taken a day before the patient's next treatment so only a subset of the tasks are shown. Using a touch screen display, each task illustrated in the care plan of FIG. 16 may be accessed. As shown, the system (100) has standardized the temperature and weight values in the unified care plan from Celcius (° C.) and Kilograms (kg), as shown in care plan 1400 of FIG. 14A, to Fahrenheit (° F.) and pounds (lbs), respectively. Also as shown, the system (100) has removed the hazardous task combination directing the patient to take the medications Tysabri and Remicade. The system (100) has flagged the combination of these medication for review by a user i.e., an authorized nurse or physician. However, the flag can be later removed by the user (and the tasks merged within the unified care plan) after the hazard has been reviewed.

As one skilled in the art may appreciate, the embodiments discussed herein are not limited and may be combined or otherwise customized for each user or patient. According to the present disclosure the modules described herein may also comprise additional processes or instructions that may be executed in order to perform certain tasks described within.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A method for normalizing care plans, comprising:
digitizing, two or more care plans, if the two or more care plans are determined not to be in a common digital format;
unifying, after digitizing the two or more care plans, the two or more care plans into a unified care plan; and
communicating, the unified care plan.

2. The method of claim 1, wherein digitizing two or more care plans comprises:
converting, the two or more care plans into a common digital format;
identifying, one or more tasks in each of the two or more care plans; and
classifying, if at least one of the one or more tasks are standardized, the at least one tasks.

3. The method of claim 2, wherein if at least one of the one or more tasks are determined not to be standardized, the method comprises one or more of:
formatting, the at least one tasks;
receiving, input associated with the at least one tasks; and
associating, content with the at least one task.

4. The method of claim 2, wherein classifying the at least one tasks comprises associating one or more tags with the at least one tasks.

5. The method of claim 1, wherein communicating the unified care plan comprises one or more of:
selecting, one or more communication mediums for communicating the unified care plan; and
communicating, the unified care plan using one or more selected communication mediums.

6. The method of claim 1, wherein unifying the two or more care plans into a unified care plan comprises:
identifying, two or more care plans to be merged;
consolidating, duplicate tasks to create at least one first reference task;
consolidating, similar tasks to create at least one second reference task;
establishing data links between the reference tasks, duplicate tasks, and similar tasks; and
flagging, potentially harmful conflicts; otherwise
merging, if potential conflicts do not exist, the care plan tasks and reference tasks into a unified care plan.

7. The method of claim 5, wherein selecting one or more communication mediums comprises selecting one or more of email, text messaging, web portal, and interactive video.

8. The method of claim 1, further comprising personalizing the unified care plan, wherein personalizing includes modifying one or more of the contents, color, font, contrast, sound, orientation, metadata, or style associated with the unified care plan.

9. The method of claim 1, wherein one or more of the unified care plan content and personalization preferences may be accessed and modified through a GUI interface.

10. The method of claim 3, wherein formatting the at least one tasks comprises one or more of formatting quantitative expressions and language content using location data.

11. A non-transitory programmable storage device storing instructions that when executed by one or more processors cause the one or more processors to:
digitize, two or more care plans, if the two or more care plans are determined not to be in a common digital format;
unify, after digitizing the two or more care plans, the care plans into a unified care plan; and
communicate, the unified care plan.

12. The non-transitory programmable storage device of claim 11, wherein the instructions that cause the one or more processors to normalize the two or more care plans comprise instructions to cause the one or more processors to:
convert, the two or more care plans into a common digital format;
identify, one or more tasks in each of the one or more care plans; and
classify, if at least one of the one or more tasks are standardized, the at least one tasks.

13. The non-transitory programmable storage device of claim 12, wherein if the instructions cause the one or more processors to determine at least one of the one or more tasks are not standardized, the instructions comprise instructions to cause the one or more processors to:
format, the at least one tasks;
receive, input associated with the at least one tasks; and
associate, content with the at least one task.

14. The non-transitory programmable storage device of claim 12, wherein the instructions that cause the one or more processors to classify the at least one tasks comprise instructions to cause the one or more processors to associate one or more tags with the at least one tasks.

15. The non-transitory programmable storage device of claim 11, wherein the instructions that cause the one or more processors to communicate the unified care plan cause the one or more processors to one or more of:
select, one or more communication mediums for communicating the unified care plan; and
communicate, the unified care plan using one or more selected communication mediums.

16. The non-transitory programmable storage device of claim 11, wherein the instructions that cause the one or more processors to unify the care plans into a unified care plan comprise instructions to cause the one or more processors to:
identify, two or more care plans to be merged;
consolidate, duplicate tasks to create at least one first reference task;
consolidate, similar tasks to create at least one second reference task;
establish data links between the reference tasks, duplicate tasks, and similar tasks; and
flag potentially harmful conflicts; otherwise
merge, if potential conflicts do not exist, the care plan tasks and reference tasks into a unified care plan.

17. The non-transitory programmable storage device of claim 15, wherein the instructions that cause the one or more processors to select one or more communication mediums comprise instructions to cause the one or more processors to select one or more of email, text messaging, web portal, and interactive video.

18. The non-transitory programmable storage device of claim 11, further comprising instructions to cause the one or more processors to personalize the unified care plan, wherein the instructions to cause the one or more processors to personalize include instructions to cause the one or more processors to modify one or more of the contents, color, font, contrast, sound, orientation, metadata, or style associated with the unified care plan.

19. The non-transitory programmable storage device of claim 11, wherein one or more of the unified care plan content and personalization preferences may be accessed and modified through a GUI interface.

20. The non-transitory programmable storage device of claim 13, wherein the instructions that cause the one or more processors to format the at least one tasks comprise instructions to cause the one or more processors to format one or more of quantitative expressions and language content using location data.
